(19) United States
(12) Patent Application Publication
(10) Pub. No.: US 2025/0252771 A1
(43) Pub. Date: Aug. 7, 2025

(54) TECHNIQUES FOR GESTURE RECOGNITION IN EGOCENTRIC VISION SENSORS WITH MULTIPLE USERS

(71) Applicant: ELECTRONICS AND TELECOMMUNICATIONS RESEARCH INSTITUTE, Daejeon (KR)

(72) Inventors: Soonchan PARK, Daejeon (KR); Youn Hee GIL, Daejeon (KR); Moon Wook RYU, Daejeon (KR); Seong Min BAEK, Daejeon (KR); Hee Sook SHIN, Daejeon (KR); Cho Rong YU, Daejeon (KR); Junseong LEE, Daejeon (KR); Sung Jin HONG, Daejeon (KR)

(73) Assignee: ELECTRONICS AND TELECOMMUNICATIONS RESEARCH INSTITUTE, Daejeon (KR)

(21) Appl. No.: 18/952,427

(22) Filed: Nov. 19, 2024

(30) Foreign Application Priority Data
Feb. 5, 2024 (KR) 10-2024-0017378

(51) Int. Cl. G06V 40/10; G06V 10/12; G06V 10/776

(52) U.S. Cl. CPC G06V 40/10; G06V 10/12; G06V 10/776

(57) ABSTRACT

Various embodiments of human motion recognition technology in an egocentric capture environment are disclosed. In one embodiment, a posture estimation apparatus comprises: a first estimation unit configured to estimate a user's posture based on a first image obtained through a first sensor attached to the user, the first image comprising an image of at least a portion of the user, and to generate first information representing the estimated posture; and an improvement unit configured to generate second information by improving the first information based on a second image obtained through a second sensor having a different shooting direction from the first sensor.

### CROSS REFERENCE TO RELATED APPLICATION

The present application claims priority to Korean Patent Application No. 10-2024-0017378, filed on Feb. 5, 2024, the entire contents of which are incorporated herein for all purposes by this reference.

### BACKGROUND

### Technical Field

The present disclosure relates to technology for estimating or recognizing a person's posture or gesture. More specifically, some embodiments relate to a technique for performing gesture recognition by more accurately and stably extracting the posture of a user in a system that includes sensors attached to the user's body to capture the user.

### Description of the Related Art

With the development of various sensor systems, a variety of applications have been released that analyze human gesture (or motion) by installing sensors (cameras) in specific spaces and utilizing the results captured and analyzed within the field of view of those sensors. Examples of such sensor systems include Microsoft's Kinect technology and Sony's MOVE. These systems may face several constraints, such as needing to ensure that the entire area is within the sensor's field of view and minimizing interference between sensors, especially for content requiring interaction in a larger space rather than performing actions in place. Furthermore, although egocentric vision sensors are being developed to overcome these field of view limitations, there may still be other constraints such as viewpoint limitations.

### SUMMARY

Therefore, gesture recognition systems may require several aspects (e.g., overcoming the limitations of the field of view, overcoming the limitations of viewpoint, and/or accurate and stable posture estimation/gesture recognition).

One aspect of this disclosure provides a posture estimation apparatus. The posture estimation apparatus may comprise: a first estimation unit configured to estimate a user's posture based on a first image obtained through a first sensor attached to the user, the first image comprising an image of at least a portion of the user, and to generate first information representing the estimated posture; and an improvement unit configured to generate second information by improving the first information based on a second image obtained through a second sensor having a different shooting direction from the first sensor.

In some embodiments, the improvement unit may generate the second information based on a change amount of the second image. In some embodiments, the change amount of the second image may comprise at least one of a relative positional change and a relative size change of objects in frames included in the second image.

In some embodiments, the improvement unit may generate the second information based on a change amount of the first image and a change amount of the second image. In some embodiments, the change amount of the first image may comprise at least one of a relative positional change and a relative size change of objects in frames included in the first image.

In some embodiments, the posture estimation apparatus may further comprise: a communication unit configured to transmit the second information to another apparatus that receives posture estimation information about the user from at least one other posture estimation apparatus and generates third information comprising posture estimation information about the user generated by improving the second information based on the posture estimation information received from the at least one other posture estimation apparatus; to receive the third information from the another apparatus; and a posture determination unit configured to determine the user's posture based on the received third information.

In some embodiments, the second information may comprise estimation reliability information for each of a plurality of elements constituting the estimated posture.

In some embodiments, the posture estimation apparatus may further comprise: a second estimation unit configured to estimate a posture of a user of another posture estimation apparatus and to generate posture estimation information representing the estimated posture based on an image obtained through the second sensor when the image includes an image of the user of the another posture estimation apparatus; and a communication unit configured to transmit the generated posture estimation information to another apparatus that improves posture estimation information about the user of the another posture estimation apparatus received from the another posture estimation apparatus based on the generated posture estimation information.

In some embodiments, the first sensor may be mounted on the user's upper body and be configured to substantially shoot in the direction of the user's lower body. In some embodiments, the shooting direction of the second sensor may be configured to substantially be aligned with the user's line of sight. In some embodiments, the first sensor may be mounted on the user's head and be configured to shoot downward relative to the user's head. In some embodiments, the second sensor may be mounted on the user's head and be configured to shoot forward relative to the user's head.

Another aspect of this disclosure provides a posture estimation information improvement apparatus. The posture estimation information improvement apparatus may comprise: a communication unit configured to receive first posture estimation information, the first posture estimation information comprising information estimating a posture of a specific user based on images captured by a first user apparatus, from the first user apparatus; and to receive second posture estimation information, the second posture estimation information comprising information estimating a posture of the specific user based on images captured by a second user apparatus, from the second user apparatus; and an improvement unit configured to generate third posture estimation information regarding the specific user based on the first posture estimation information and the second posture estimation information. In some embodiments, the communication unit may be configured to transmit the generated third posture estimation information to at least one of the first user apparatus and the second user apparatus.

In some embodiments, each of the first posture estimation information and the second posture estimation information may include estimation reliability information for each of a plurality of elements constituting the estimated posture. In some embodiments, the improvement unit may be configured to generate the third posture estimation information based on the estimation reliability information included in the first posture estimation information and the estimation reliability information included in the second posture estimation information.

In some embodiments, the first posture estimation information may include posture estimation information of the user of the first user apparatus generated based on at least an image obtained through a first sensor of the first user apparatus. In some embodiments, the second posture estimation information may include posture estimation information of the user of the first user apparatus generated based on an image obtained through a second sensor of the second user apparatus. In some embodiments, the improvement unit may be configured to generate the third posture estimation information by improving the first posture estimation information based on the second posture estimation information.

In some embodiments, the first posture estimation information may include posture estimation information of the user of the first user apparatus generated based on images obtained through both the first sensor and a second sensor of the first user apparatus. In some embodiments, the first sensor of the first user apparatus may be attached to the user of the first user apparatus and capture at least a part of the user of the first user apparatus. In some embodiments, the second sensor of the first user apparatus may capture in the direction of the line of sight of the user of the first user apparatus. In some embodiments, the second sensor of the second user apparatus may capture in the direction of the line of sight of the user of the second user apparatus.

Another aspect of this disclosure provides a posture estimation method. The posture estimation method may comprise: estimating a user's posture based on a first image obtained through a first sensor attached to the user, the first image comprising an image of at least a portion of the user, and generating first information representing the estimated posture; and generating second information by improving the first information based on a second image obtained through a second sensor having a different shooting direction from the first sensor.

In some embodiments, the generating the second information may comprise generating the second information based on a change amount of the second image.

In some embodiments, the generating the second information may comprise generating the second information based on a change amount of the first image and a change amount of the second image.

In some embodiments, the posture estimation method may further comprise: transmitting the second information to another apparatus that receives posture estimation information about the user from at least one other posture estimation apparatus and generates third information comprising posture estimation information about the user generated by improving the second information based on the posture estimation information received from the at least one other posture estimation apparatus; receiving the third information from the another apparatus; and determining the user's posture based on the received third information.

In some embodiments, the posture estimation method may further comprise: estimating a posture of a user of another posture estimation apparatus and generating posture estimation information representing the estimated posture based on an image obtained through the second sensor when the image includes an image of the user of the another posture estimation apparatus; and transmitting the generated posture estimation information to another apparatus that improves posture estimation information about the user of the another posture estimation apparatus received from the another posture estimation apparatus based on the generated posture estimation information.

In some embodiments, the first sensor may be mounted on the user's upper body and be configured to substantially shoot in the direction of the user's lower body. In some embodiments, the shooting direction of the second sensor may be configured to substantially be aligned with the user's line of sight.

Another aspect of this disclosure provides an electronic device comprising: a processor; one or more hardware-based transceivers; and a computer-readable storage medium containing instructions, which, in response to execution by the processor, cause the electronic device to perform at least one embodiment of the method of this disclosure.

Another aspect of this disclosure provides a non-transitory recording medium storing instructions readable by a processor of an electronic device, wherein the instructions cause the processor to perform embodiments of this disclosure.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, it is possible to overcome the problems of conventional methods that estimate posture using user self-captured images (e.g., increased depth ambiguity, severe occlusion).

### BRIEF DESCRIPTION OF THE DRAWINGS

FIG. 1 illustrates a sensor environment in which a self-capturing viewpoint and an external capturing viewpoint coexist.

FIGS. 2A and 2B illustrate the information acquired from each viewpoint when performing a squatting action.

FIG. 3 is a diagram for explaining some embodiments of a posture estimation system.

FIG. 4 is a diagram for illustrating some embodiments of user posture estimation through a user posture maintenance system.

FIG. 5 is a flowchart illustrating some embodiments of the operation of user A apparatus of FIG. 4.

FIG. 6 is a flowchart illustrating certain embodiments of the operation of user B apparatus of FIG. 4.

FIG. 7 is a flowchart illustrating some embodiments of the operation of the user posture maintenance system of FIG. 4.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

Recently, due to the significant reduction in sensor weight, sensor systems with egocentric vision that are installed on frames attached to a user's body (e.g., helmet, shoulder) and face the user themselves have been developed. These systems overcome the field of view limitations inherent in conventional sensors by attaching sensors (hereinafter referred to as “Sensor1”) to the user, thereby capturing the user's body regardless of the user's movement, and analyzing the captured video (e.g., user movement within the video) to reflect it in content.

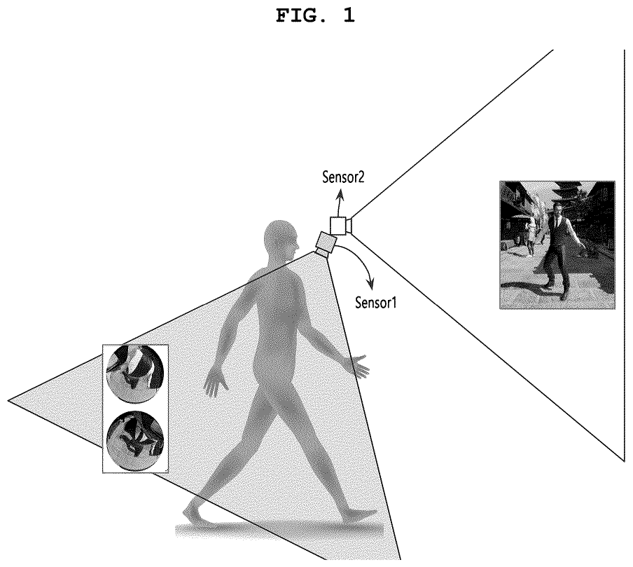

FIG. 1 illustrates a sensor environment in which a self-capturing viewpoint and an external capturing viewpoint coexist.

In some embodiments, in addition to the “egocentric vision sensor” that faces the user themselves, a sensor (hereinafter referred to as “Sensor2”) is additionally installed as shown in FIG. 1 to capture first-person viewpoint images indicating the direction in which the user's head is facing, for the purpose of recognizing not only the user's state but also the external environment.

Because Sensor1, which is attached to the user's body for capturing, has a very short distance between the sensor and the user's body, the field of view (i.e., the captured subject or capture angle) may be limited. For example, even when assuming a fisheye lens environment that maximizes the field of view, there are cases where only the face or upper body is barely included in the field of view, and the lower body appears very small or is obscured by the upper body and thus not visible. On the other hand, from a third-person viewpoint, estimating the overall posture, especially that of the lower body, can operate more easily.

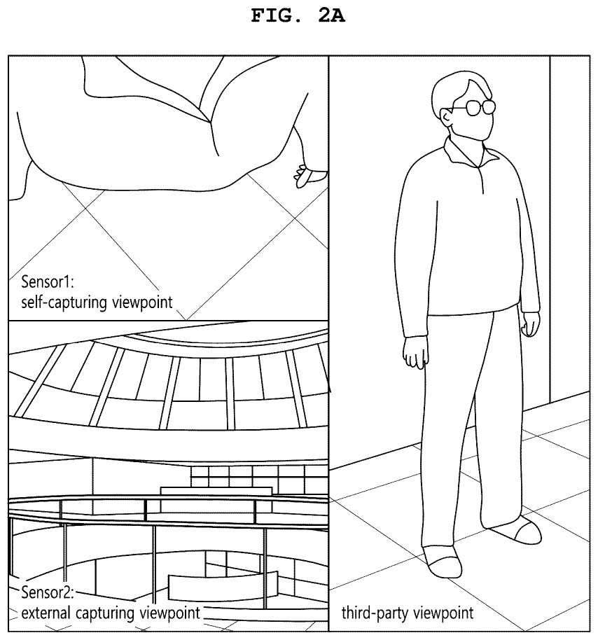

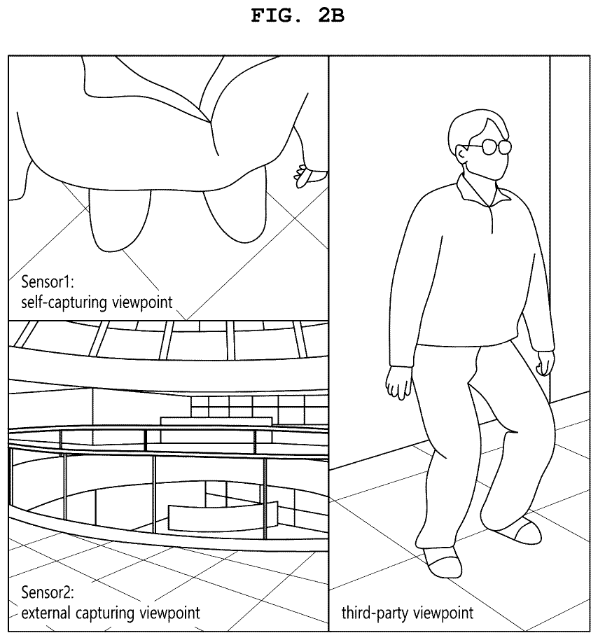

FIGS. 2A and 2B illustrate the information acquired from each viewpoint when performing a squatting action.

More specifically, FIG. 2A exemplifies the images that can be acquired before performing a squatting action, while FIG. 2b exemplifies the images that can be acquired while in a squatting position.

In each of FIGS. 2A and 2B, the top-left image illustrates an image that can be acquired through Sensor1, the bottom-left image illustrates an image that can be acquired through Sensor2, and the right image illustrates an image that can be acquired through a third-party viewpoint (or sensor).

As illustrated in FIGS. 2A and 2B, the situation captured by Sensor1, which is oriented to look downwards, may result in increased depth ambiguity in the vertical direction. For example, with the information obtained from Sensor1 alone, it may be difficult to distinguish whether the user is standing or sitting.

Therefore, as illustrated in FIGS. 2A and 2B, when the user's posture changes from standing to squatting, although the posture has significantly changed, the difference in the information obtained by Sensor1 may be minimal, making accurate estimation challenging.

In this way, while posture estimation in a system using both Sensor1 and Sensor2 has the advantage of expanding the range of user interactions regardless of user movement, the two prominent issues due to the viewpoint limitations of Sensor1 installed above the user's head (i.e., increased ambiguity in the vertical direction and severe occlusion) may result in inaccurate posture estimation, thereby reducing the stability of the subsequent gesture recognition technology.

Therefore, there is a need for technologies that overcome the viewpoint limitations arising from egocentric vision captured by Sensor1, enabling more accurate and reliable posture estimation and gesture recognition.

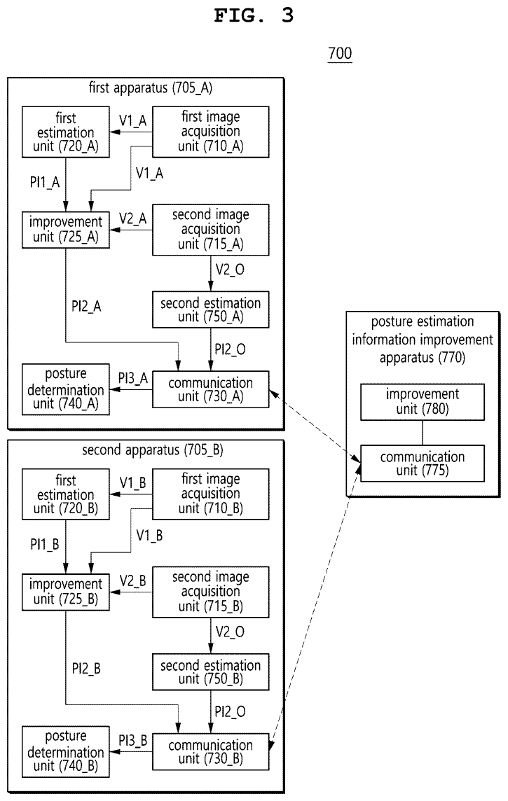

FIG. 3 is a diagram for explaining some embodiments of a posture estimation system.

In some embodiments, as illustrated in FIG. 3, the posture estimation system (700) may include a first apparatus (705_A), a second apparatus (705_B), and a posture estimation information improvement apparatus (770). In other embodiments, the posture estimation system (700) may include additional apparatuses similar to the first apparatus (705_A) and second apparatus (705_B).

In some embodiments, at least a portion of each of the first apparatus (705_A) and the second apparatus (705_B) (for example, a first image acquisition unit) may be attached to the respective user (for example, a first user and a second user). In other embodiments, at least a portion of each of the first apparatus (705_A) and the second apparatus (705_B) may be carried by the respective user. Furthermore, in yet other embodiments, at least a portion of the first apparatus (705_A) and the second apparatus (705_B) (for example, the second apparatus) may exist near the user without being attached to or carried by the user.

For convenience, herein, some embodiments of the present disclosure will be described assuming that the first apparatus (705_A) is carried by the first user and the second apparatus (705_B) is carried by the second user.

In some embodiments, as illustrated in FIG. 3, the first apparatus (705_A) may include at least some of a first image acquisition unit (710_A), a second image acquisition Unit (715_A), a first estimation unit (720_A), an improvement unit (725_A), a communication unit (730_A), a posture determination unit (740_A), and a second estimation unit (750_A).

In some embodiments, the second apparatus (705_B) may also have a structure similar to that of the first apparatus (705_A) as illustrated in FIG. 3. In other embodiments, the second apparatus (705_B) may have a structure different from that of the first apparatus (705_A) to perform only corresponding operations according to some embodiments of the first apparatus (705_A).

In some embodiments, some of the constituent blocks included in each of the first apparatus (705_A) and the second apparatus (705_B) (for example, the first estimation unit, improvement unit, second estimation unit, and/or posture determination unit) may be constituted by a single physical device block (for example, a processor and memory).

In some embodiments, as illustrated in FIG. 3, the posture estimation information improvement apparatus (770) may include a communication unit (775) and an improvement unit (780). In some embodiments, the posture estimation information improvement apparatus (770) may be implemented as a server system. In some embodiments, the first apparatus (705_A), the second apparatus (705_B), and the posture estimation information improvement apparatus (770) may be connected via wired or wireless communication networks to exchange information.

For convenience, herein, some embodiments of the present disclosure will be described primarily based on the configuration of the first apparatus (705_A).

In some embodiments, the first image acquisition unit (710_A) may include the first sensor attached to the user. In some embodiments, the first image acquisition unit (710_A) may acquire a first image (V1_A) through the first sensor. In some embodiments, the first image (V1_A) may include an image of at least a portion of the first user.

In some embodiments, the first estimation unit (720_A) may estimate the posture of the first user based on the first image (V1_A) and generate first information (PI1_A) representing the estimated posture.

In some embodiments, the second image acquisition unit (715_A) may include a second sensor having a different shooting direction from the first sensor of the first image acquisition unit (710_A). In some embodiments, the second image acquisition unit (715_A) may acquire a second image (V2_A).

In some embodiments, the first sensor may be attached to the upper body of the user and configured to capture images in the direction of the user's lower body, and the imaging direction of the second sensor may substantially face the user's line of sight. for example, the first sensor may be mounted on the user's head and configured to capture images downward relative to the user's head, and the second sensor may be mounted on the user's head and configured to capture images forward relative to the user's head.

In some embodiments, the improvement unit (725_A) may improve the first information (PI1_A) based on the second image (V2_A) to generate second information (PI2_A).

In some embodiments, the improvement unit (725_A) may generate the second information (PI2_A) based on the change amount of the second Image (V2_A). In other embodiments, the improvement unit (725_A) may generate the second information (PI2_A) based on the change amount of the first image (V1_A) and the change amount of the second image (V2_A). In yet other embodiments, the improvement unit (725_A) may generate the second information (PI2_A) based on the change amount of the first image (V1_A).

In some embodiments, the change amount of the second image (V2_A) may include at least one of the relative positional change and the relative size change of objects in the frames included in the second image (V2_A). In some embodiments, the change amount of the first image (V1_A) may include at least one of the relative positional change and the relative size change of objects in the frames included in the first image (V1_A).

In some embodiments, the communication unit (730_A) may transmit the second information (PI2_A) to the posture estimation information improvement apparatus (770).

In some embodiments, when each of the first apparatus (705_A) and the second apparatus (705_B) acquires an image (V2_0) including another user (for example, a user who is neither the first user of the first apparatus nor the second user of the second apparatus) through the second image acquisition units (715_A, 715_B), the second estimation units (750_A, 750_B) included in the first apparatus (705_A) and the second apparatus (705_B) may perform posture estimation regarding the respective user based on the acquired image (V2_O) and transmit the information (PI2_O) to the posture estimation information improvement apparatus (770).

In some embodiments, the communication unit (775) of the posture estimation information improvement apparatus (770) may receive posture estimation information regarding a specific user from each user apparatus (for example, the first apparatus (705_A), the second apparatus (705_B), and other apparatuses not shown in FIG. 3). Here, the posture estimation information may include information estimating the posture of the specific user based on images captured by each user apparatus's imaging units (first sensor and/or second sensor). For example, the communication unit (775) of the posture estimation information improvement apparatus (770) may receive the first posture estimation information (PI2_A) regarding the user of the first apparatus (705_A) from the communication unit (730_A) of the first apparatus (705_A), and may receive the second posture estimation information (PI2_B) regarding the user of the first apparatus (705_A) from the communication unit (730_B) of the second apparatus (705_B).

In some embodiments, the improvement unit (780) of the posture estimation information improvement apparatus (770) may generate third posture estimation information (PI3_A) regarding the user of the first apparatus (705_A) based on the first posture estimation information (PI2_A) and the second posture estimation information (PI2_B). In some embodiments, the improvement unit (780) of the posture estimation information improvement apparatus (770) may generate the third posture estimation information (PI3_A) by improving the first posture estimation information (PI2_A) based on the second posture estimation information (PI2_B). In some embodiments, each of the first posture estimation information (PI2_A) and the second posture estimation information (PI2_B) may include estimation reliability information for each of a plurality of elements constituting the estimated posture (for example, each joint). In some embodiments, the improvement unit (780) may generate the third posture estimation information (PI3_A) based on the estimation reliability information included in the first posture estimation information (PI2_A) and the estimation reliability information included in the second posture estimation information (PI2_B).

In some embodiments, the communication unit (775) of the posture estimation information improvement apparatus (770) may transmit the third posture estimation information (PI3_A) to the first apparatus (705_A).

In some embodiments, the first apparatus (705_A) may receive the third posture estimation information (PI3_A) through the communication unit (730_A) and determine the posture of the user of the first apparatus (705_A) based on the third posture estimation information (PI3_A) through the posture determination unit (740_A). In some embodiments, the posture determination unit (740_A) may recognize the gesture of the first user based on the estimated posture.

In some embodiments, the second estimation unit (750_A) of the first apparatus (705_A) may estimate the posture of the user of another posture estimation apparatus (e.g., the second apparatus) based on the image obtained through the second sensor if the image includes an image of the user of the other posture estimation apparatus, and generate posture estimation information (PI2_O) indicating the estimated posture.

In some embodiments, the communication unit (730_A) of the first apparatus (705_A) may transmit the generated posture estimation information (PI2_O) to the posture estimation information enhancement apparatus (770). In this case, similar to the principle described above, the posture estimation information enhancement apparatus (770) may generate posture estimation information (PI3_B) about the user of the second apparatus (705_B) based on the posture estimation information (PI2_O) received from the first apparatus (705_A) and the posture estimation information (PI2_B) received from the second apparatus (705_B), and transmit it to the second apparatus (705_B).

In some embodiments, the first apparatus (705_A) may perform operations similar to those of the second image acquisition unit (715_B), the second estimation unit (750_B), and the communication unit (730_B) of the second apparatus (705_B) as described above.

Some embodiments assume an environment where user A installs at least two sensors on their head. There is a sensor 1 that captures the user's own appearance from above and a sensor 2 that acquires external information in the direction the user's head is facing. Each sensor may be configured as a general RGB camera, an infrared camera, a depth sensor, a stereo vision sensor system, or a combination of multiple sensors.

In this case, following the same principle as described above, the posture estimation information improvement apparatus (770) may generate posture estimation information (PI3_B) regarding the user of the second apparatus (705_B) based on the posture estimation information (PI2_O) received from the first apparatus (705_A) and the posture estimation information (PI2_B) received from the second apparatus (705_B), and may transmit it to the second apparatus (705_B).

In some embodiments, the first apparatus (705_A) may also perform operations similar to those of the Second Image Acquisition Unit (715_B), Second Estimation Unit (750_B), and Communication Unit (730_B) of the Second apparatus (705_B) as described above.

Some embodiments, which will be described later, assume an environment where User A has at least two sensors installed above their head. Sensor1 captures images of the user's own body from a top-down perspective, and Sensor2 is used to acquire external information in the direction the user's head is facing. Each sensor may be configured as a standard RGB camera, an infrared camera, a depth sensor, a stereo vision sensor system, or a combination of multiple sensors.

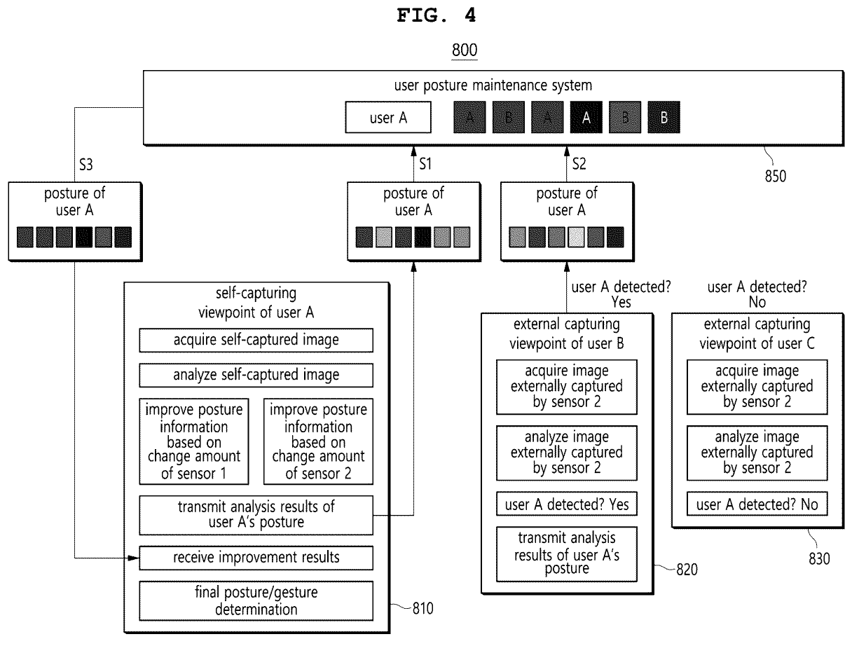

FIG. 4 is a diagram for illustrating some embodiments of user posture estimation through a user posture maintenance system.

In some embodiments, the system (800) illustrated in FIG. 4 may recognize the posture and gesture of a user A.

In some embodiments, the system (800), as illustrated in FIG. 4, may include a user A apparatus (810), a user B apparatus (820), a user C apparatus (830), and a user posture maintenance system (850).

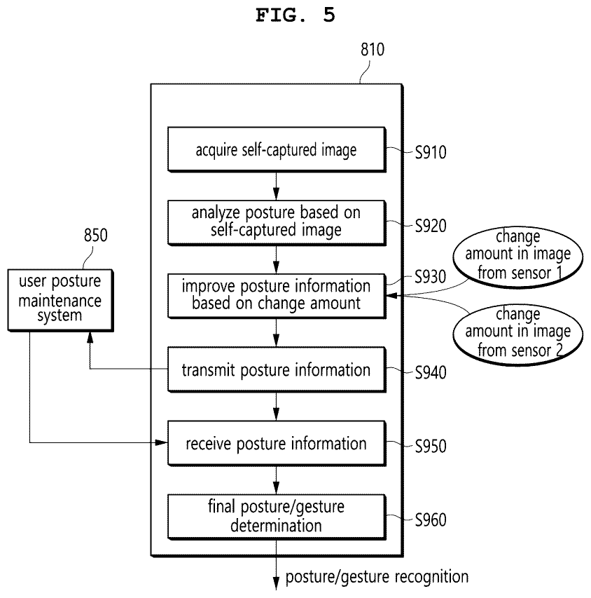

FIG. 5 is a flowchart illustrating some embodiments of the operation of user A apparatus (810) of FIG. 4.

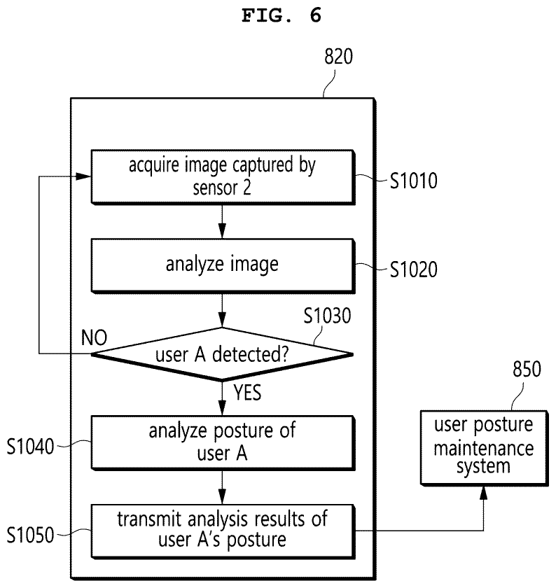

FIG. 6 is a flowchart illustrating certain embodiments of the operation of user B apparatus (820) of FIG. 4.

FIG. 5 illustrates the process by which each apparatus estimates the posture of a user who is the subject of its own image acquisition (for example, user A for user A apparatus (810), user B for user B apparatus (820), and user C for user C apparatus (830)).

FIG. 6 illustrates the process by which each apparatus estimates the posture of a user who is not the subject of its own image acquisition.

That is, FIGS. 5 and 6 may be commonly performed by user A apparatus (810), user B apparatus (820), and user C apparatus (830) of FIG. 4. However, since FIG. 4 assumes that only user A is detected, the embodiments of FIG. 5 are described assuming they are performed by user A apparatus (810), and the embodiments of FIG. 6 are described assuming they are performed by user B apparatus (820).

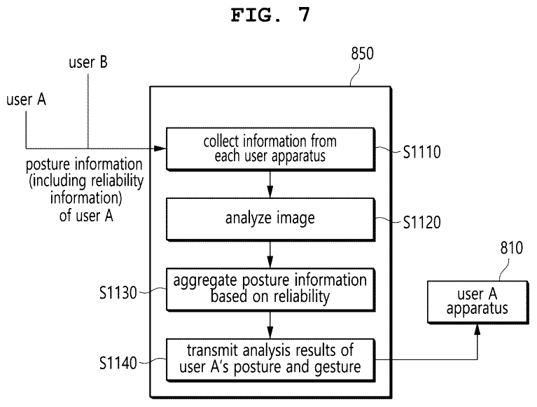

FIG. 7 is a flowchart illustrating some embodiments of the operation of the user posture maintenance system (850) of FIG. 4.

In some embodiments, the user A apparatus (810) may correspond to the first apparatus (705_A) of FIG. 3.

In some embodiments, as illustrated in FIG. 4, the user A apparatus (810) may acquire a self-captured image through the sensor 1 worn by user A (S910) and analyze the acquired self-captured image to initially infer the posture estimation result (S920). At this point, due to the limitations of the viewpoint, some joints may be estimated with low reliability.

In some embodiments, the user A apparatus (810) may improve the posture estimation result by reflecting the change amount of the information from sensor 1 and sensor 2 in addition to the initially inferred posture (S930).

Since the sensor 1 image of the user A apparatus (810) is captured from a top-down view, the uncertainty in the vertical direction may be very high. For example, when user A moves up and down, such as squatting, the captured image may not change significantly, leading to similar results (i.e., similar images before and after squatting). As illustrated in the top-left images of FIGS. 2A and 2B, since there is no significant change in the upper body that occupies most of the egocentric image when user A squats, the resulting image may not be significantly different.

However, the user A apparatus (810) may extract data based on the change amount of information obtained from sensor 1 and sensor 2 and improve the posture information using this data. At this point, there may be an effect similar to zooming in with sensor 1, and a change amount in sensor 2 where the overall viewpoint descends and then rises again can be measured.

In some embodiments, the user A apparatus (810) may transmit the posture information (S1) to the user posture maintenance system (850) (S940). Similarly, in some embodiments, the user B apparatus (820) may transmit the posture information (S2) about user A (S1050). In some embodiments, before transmitting the posture information (S2), the user B apparatus (820) can perform sensor 2 image acquisition (S1010), image analysis (S1020), user A detection confirmation through image analysis (S1030), and user A posture analysis (S1040). If user detection is not confirmed in the user A detection confirmation step (S1030), the process may return to S1010 without proceeding to S1040.

In some embodiments, the posture information (S2) transmitted by the user A apparatus (810) to the user posture maintenance system (850) and the posture information (S3) transmitted by the user posture maintenance system (850) to the user A apparatus (810) may include reliability information. Referring to FIG. 4, the reliability information is visualized in grayscale for convenience, wherein higher reliability is depicted closer to black and lower reliability is depicted closer to white.

For example, in posture information (S1), among the six estimation elements (e.g., joints), the second, fifth, and sixth elements appear in relatively light colors, indicating low-reliability estimations. Conversely, posture information (S2), unlike S1, shows the second, fifth, and sixth elements in relatively dark colors, indicating that their reliability levels are not low.

In some embodiments, the user A apparatus (810) may transmit the posture information (S1) obtained in the step S930 (S940).

Meanwhile, if the sensor 2 of user B apparatus (820) and the user C apparatus (830) which are apparatuses of third-party have captured user A, the system (800) may utilize this information to perform posture estimation.

Referring to FIG. 4, since user A is not detected on the sensor 2 screen of the user C apparatus (830), related information may not be transmitted from the user C apparatus (830) to the user posture maintenance system (850).

If the sensor 2 of the user B apparatus (820) and the user C apparatus (830) have captured user A, the acquired information, having a different viewpoint from the self-viewpoint image of the user A apparatus (810), may be used to estimate the posture of user A with high reliability, especially for the lower body, which may have significant occlusion in the self-viewpoint image.

Referring to FIG. 4, the information (S2) acquired from the user B apparatus (820) may be transmitted to the user posture maintenance system (850) (S1050).

In some embodiments, the user posture maintenance system (850) may distinguish each user through recognition.

In some embodiments, the user posture maintenance system (850) may collect various pieces of information about user A (S1, S2 in FIG. 4) (S1110) and aggregate this information based on reliability information to determine the posture of user A (S1120, S1130).

In some embodiments, the information (S3) about the posture determined by the user posture maintenance system (850) may be transmitted back to the user A apparatus (810) (S1140, S950). The user A apparatus (810) may reflect the received information (S3) on the second, fifth, and sixth joints, which had limitations in the self-captured viewpoint, to achieve an overall high-reliability information estimation result. This may be due to the high-reliability information estimates for the second, fifth, and sixth joints contained in the received information (S3).

Meanwhile, as described above, since the sensor 2 of the user C apparatus (830) does not have a viewpoint looking at user A, there is no related information transmission to the user posture maintenance system (850), and it may not contribute to the posture estimation of user A in the system (800).

In some embodiments, when the user A apparatus (810) requires posture information of user A, it may request the user posture maintenance system (850), and the user posture maintenance system (850) may respond by sending the current posture information (S3) of user A, updated based on reliability, to the user A apparatus (810).

In some embodiments, the user A apparatus (810) may finalize the posture and gesture based on the received information (S3) (S960) and reflect it in the content.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random-access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor a controller. In addition, different processing and configurations are possible, such as parallel processors.

Also, non-transitory computer-readable media may be any available media that may be accessed by a computer and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above-described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A posture estimation apparatus comprising:
a first estimation unit configured to estimate a user's posture based on a first image obtained through a first sensor attached to the user, the first image comprising an image of at least a portion of the user, and to generate first information representing the estimated posture; and
an improvement unit configured to generate second information by improving the first information based on a second image obtained through a second sensor having a different shooting direction from the first sensor.

2. The posture estimation apparatus of claim 1, wherein the improvement unit generates the second information based on a change amount of the second image.

3. The posture estimation apparatus of claim 2, wherein the change amount of the second image comprises at least one of a relative positional change and a relative size change of objects in frames included in the second image.

4. The posture estimation apparatus of claim 1, wherein the improvement unit generates the second information based on a change amount of the first image and a change amount of the second image.

5. The posture estimation apparatus of claim 4, wherein the change amount of the first image comprises at least one of a relative positional change and a relative size change of objects in frames included in the first image.

6. The posture estimation apparatus of claim 1, further comprising:
a communication unit configured to transmit the second information to another apparatus that receives posture estimation information about the user from at least one other posture estimation apparatus and generates third information comprising posture estimation information about the user generated by improving the second information based on the posture estimation information received from the at least one other posture estimation apparatus and configured to receive the third information from the another apparatus; and
a posture determination unit configured to determine the user's posture based on the received third information.

7. The posture estimation apparatus of claim 6, wherein the second information comprises estimation reliability information for each of a plurality of elements constituting the estimated posture.

8. The posture estimation apparatus of claim 1, further comprising:
a second estimation unit configured to estimate a posture of a user of another posture estimation apparatus and to generate posture estimation information representing the estimated posture based on an image obtained through the second sensor when the image includes an image of the user of the another posture estimation apparatus; and
a communication unit configured to transmit the generated posture estimation information to another apparatus that improves posture estimation information about the user of the another posture estimation apparatus received from the another posture estimation apparatus based on the generated posture estimation information.

9. The posture estimation apparatus of claim 1, wherein:
the first sensor is mounted on the user's upper body and is configured to substantially shoot in the direction of the user's lower body; and
the shooting direction of the second sensor is configured to substantially be aligned with the user's line of sight.

10. The posture estimation apparatus of claim 9, wherein:
the first sensor is mounted on the user's head and is configured to shoot downward relative to the user's head; and
the second sensor is mounted on the user's head and is configured to shoot forward relative to the user's head.

11. A posture estimation information improvement apparatus comprising:
a communication unit configured to receive first posture estimation information, the first posture estimation information comprising information estimating a posture of a specific user based on images captured by a first user apparatus, from the first user apparatus and configured to receive second posture estimation information, the second posture estimation information comprising information estimating a posture of the specific user based on images captured by a second user apparatus, from the second user apparatus; and
an improvement unit configured to generate third posture estimation information regarding the specific user based on the first posture estimation information and the second posture estimation information;
wherein the communication unit is configured to transmit the generated third posture estimation information to at least one of the first user apparatus and the second user apparatus.

12. The posture estimation information improvement apparatus of claim 11, wherein:
each of the first posture estimation information and the second posture estimation information includes estimation reliability information for each of a plurality of elements constituting the estimated posture; and
the improvement unit is configured to generate the third posture estimation information based on the estimation reliability information included in the first posture estimation information and the estimation reliability information included in the second posture estimation information.

13. The posture estimation information improvement apparatus of claim 11, wherein:
the first posture estimation information includes posture estimation information of the user of the first user apparatus generated based on at least an image obtained through a first sensor of the first user apparatus;
the second posture estimation information includes posture estimation information of the user of the first user apparatus generated based on an image obtained through a second sensor of the second user apparatus; and
the improvement unit is configured to generate the third posture estimation information by improving the first posture estimation information based on the second posture estimation information.

14. The posture estimation information improvement apparatus of claim 13, wherein:
the first posture estimation information includes posture estimation information of the user of the first user apparatus generated based on images obtained through both the first sensor and a second sensor of the first user apparatus;
the first sensor of the first user apparatus is attached to the user of the first user apparatus and captures at least a part of the user of the first user apparatus;
the second sensor of the first user apparatus captures in the direction of the line of sight of the user of the first user apparatus; and
the second sensor of the second user apparatus captures in the direction of the line of sight of the user of the second user apparatus.

15. A posture estimation method comprising:
estimating a user's posture based on a first image obtained through a first sensor attached to the user, the first image comprising an image of at least a portion of the user, and generating first information representing the estimated posture; and
generating second information by improving the first information based on a second image obtained through a second sensor having a different shooting direction from the first sensor.

16. The posture estimation method of claim 15, wherein the generating the second information comprises generating the second information based on a change amount of the second image.

17. The posture estimation method of claim 15, wherein the generating the second information comprises generating the second information based on a change amount of the first image and a change amount of the second image.

18. The posture estimation method of claim 15, further comprising:
transmitting the second information to another apparatus that receives posture estimation information about the user from at least one other posture estimation apparatus and generates third information comprising posture estimation information about the user generated by improving the second information based on the posture estimation information received from the at least one other posture estimation apparatus;
receiving the third information from the another apparatus; and
determining the user's posture based on the received third information.

19. The posture estimation method of claim 15, further comprising:
estimating a posture of a user of another posture estimation apparatus and generating posture estimation information representing the estimated posture based on an image obtained through the second sensor when the image includes an image of the user of the another posture estimation apparatus; and
transmitting the generated posture estimation information to another apparatus that improves posture estimation information about the user of the another posture estimation apparatus received from the another posture estimation apparatus based on the generated posture estimation information.

20. The posture estimation method of claim 15, wherein:
the first sensor is mounted on the user's upper body and is configured to substantially shoot in the direction of the user's lower body; and
the shooting direction of the second sensor is configured to substantially be aligned with the user's line of sight.
